(19) United States
(12) Patent Application Publication
(10) Pub. No.: US 2024/0276980 A1
(43) Pub. Date: Aug. 22, 2024

(54) ADJUVANT SYSTEMS FOR IMPROVED DELIVERY OF ACTIVE INGREDIENTS USING PULSED SPRAY CROP APPLICATIONS

(71) Applicant: Winfield Solutions, LLC, Arden Hills, MN (US)

(72) Inventor: Steven Fredericks, Arden Hills, MN (US)

(73) Assignee: Winfield Solutions, LLC, Arden Hills, MN (US)

(21) Appl. No.: 18/581,208

(22) Filed: Feb. 19, 2024

Related U.S. Application Data
(60) Provisional application No. 63/446,682, filed on Feb. 17, 2023.

(51) Int. Cl. A01N 25/06; A01N 57/12; A01P 3/00; A01P 7/04; A01P 13/00; A01P 21/00

(52) U.S. Cl. CPC A01N 25/06; A01N 57/12; A01P 3/00; A01P 7/04; A01P 13/00; A01P 21/00

(57) ABSTRACT

Agricultural treatments and methods configured to be applied in a field by spraying that is pulsed, including a crop treatment having at least one active ingredient and a sufficient quantity of an adjuvant including an oil phase to provide a more consistent droplet size during pulsed spray application of the agricultural treatment. The treatment may also include a sufficient quantity of surfactant to provide the more consistent droplet size during pulsed spray application of the agricultural treatment. The quantity of oil phase may be sufficient to provide smaller shifts in volumetric median diameter and droplet size distribution when applied by spraying that is pulsed compared to a steady state spray.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Both pulse width modulation controlled sprays and machine vision based spot spraying technologies have increased the precision of agricultural pesticide application. These methods both utilize short duration spray bursts as their operating principle, as opposed to the continuous spraying employed in conventional broadcast pesticide applications. This results in a much larger fraction of the application occurring during the start-up and shut-down transience of the spray process, with a significant reduction in the fraction of time the spray is operating at steady state. Previous studies have shown that the volumetric median diameter (VMD) of a spray depend on where the measurement is made spatially within the spray fan, and there has likewise been shown to be a spatial dependence on the atomization mechanism within a spray when operating at steady state.

Spray application is one of the primary modes for field application of agrochemical products. The relative success of a spray application is largely dependent on the droplet size distribution (DSD) produced during the spraying process, as sprays that produce small droplets are susceptible to the ambient atmospheric condition and are liable to drift from the intended application target, and conversely sprays that produce large droplets can experience droplet splashing or bounce and a general lack of coverage required for optimal efficacy. To further complicate the spraying process, multiple technologies have been introduced to the market which rely on short duration spray pulses. Pulse width modulation is a technique which allows for rate control of the spray while the sprayer is traveling at changing velocities by pulsing the spray at a fixed frequency and matching the duty cycle of the spray to accommodate to changes in drive speed to maintain a consistent application rate. A second emerging method employing pulsing sprays is machine vision controlled spot spraying. This method uses an array of cameras to identify weeds as the sprayer traverses the field, then initiates a spray pulse timed to only apply spray to the identified weeds.

### BRIEF SUMMARY OF THE INVENTION

Various embodiments include agricultural treatments and methods configured to be applied in the field by spraying that is pulsed. The treatment may include a crop treatment having at least one active ingredient and a sufficient quantity of an adjuvant including an oil phase to provide a more consistent droplet size during pulsed spray application of the agricultural treatment. The adjuvant may further include a sufficient quantity of surfactant to provide the more consistent droplet size during pulsed spray application of the agricultural treatment. The sufficient quantity of oil phase may be configured to provide smaller shifts in volumetric median diameter and droplet size distribution when applied by spraying that is pulsed compared to a steady state spray. In some embodiments, the oil phase is a fatty acid ester.

Other embodiments include agricultural treatment and methods configured to be applied in the field by spraying that is pulsed including a crop treatment having at least one active ingredient; and a sufficient quantity of an emulsion forming adjuvant to provide a more consistent droplet size distribution during pulsed spray application of the agricultural treatment. The emulsion forming adjuvant may be a drift control adjuvant. The crop treatment may be an herbicide, insecticide, fungicide and/or plant growth regulators and one or more surfactants. The emulsion forming adjuvant may include a sufficient quantity of oil phase to provide a spray distribution when delivered by a pulsing regime that is closer to what would be expected of a conventional spray. In some embodiments, the oil phase may include a fatty acid ester. The emulsion forming adjuvant may include a sufficient quantity of oil phase to provide a droplet size distribution, when applied by a pulsing regime, that is closer to what is expected of a conventional spray. The agricultural treatment may also include a surfactant including a nonionic surfactant and an anionic surfactant.

Other embodiments include methods of reducing the impact of pulsed spray delivery of a crop treatment on droplet size distribution. The method may include applying a crop treatment to a crop in a pulsed spray. The crop treatment may include one or more active ingredients including an herbicide, insecticide, fungicide and/or plant growth regulator, and an adjuvant comprising an oil phase and one or more surfactants. The pulsed spray may include a spray at about 10 Hz to about 30 Hz. The pulsed spray may include a spray at a duty cycle of about 15% to about 75%. The oil phase may include a fatty acid ester, such as a one alkyl fatty acid ester. In some embodiments, the oil phase includes methylated seed oil. The one or more surfactants may include a nonionic surfactant and an anionic surfactant. In some embodiments, the oil phase may be at least about 95 wt % of the adjuvant and the surfactant may be about 3 wt % to about 5 wt % of the adjuvant. In some such examples, the oil phase may be a fatty acid ester and the at least one surfactant may be a nonionic surfactant and an anionic surfactant.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a set of representative still images of steady state sprays taken from the XC nozzle;

FIG. 2 is a time series of still images showing a close up view of the leading edge of a spray pulse taken from the XC nozzle using the surfactant laden herbicide treatment;

FIG. 3 is a time series of still images showing a close up view of the trailing edge of a spray pulse taken from the XC nozzle using the surfactant laden herbicide treatment;

FIG. 4 is a set of graphs of the % change in VMD relative to steady state for each nozzle with water shown as a function of the pulse duration for the pulse frequencies tested with each of the nozzles;

FIG. 5 is a set of graphs of the % change in VMD relative to steady state for each nozzle as a function of pulse duration when operated at 10 Hz;

FIG. 6 is a set of graphs of the % change in VMD relative to steady state for each treatment averaged across the pulsing durations tested;

FIG. 7 is a time series of still images showing a close up view of the leading edge of a spray pulse taken from the XC nozzle using the emulsion treatment;

FIG. 8 is a time series of still images showing a close up view of the trailing edge of a spray pulse taken from the XC nozzle using the emulsion treatment;

FIG. 9 is a set of still images demonstrating the method used for determining physical parameters related to the lamella demonstrated with the UC nozzle with the water treatment;

FIG. 10 is a set of graphs of the physical characteristics of the lamella in each spray as measured in steady state;

FIG. 11 is a graph of the % change in VMD relative to steady state as a function of the pulse duration scaled by the atomization timescale; and

FIG. 12 is a graph of the % change in VMD relative to steady state as a function of the pulse duration scaled by the duration of each pulse within the transient leading and trailing edges.

### DETAILED DESCRIPTION OF THE INVENTION

The present application claims priority to provisional application No. 63/446,682, entitled Parameterization of Pulsing, the disclosure of which is hereby incorporated by reference in its entirety.

As leading and trailing edges of a pulsing spray would not be expected to be governed by the same atomization physics as the center and sides of a steady state spray the present disclosure characterizes shifts in the VMD of pulsing sprays across pulse durations in the range of 15 to 75 ms relative to their steady state counterparts and identifies changes in atomization mechanism associated with the transient regimes of each pulse. Additionally, the role of nozzle and liquid components, such as formulated herbicides and adjuvants, in the spray were evaluated and it was found that the addition of an emulsion forming adjuvant tended to produce a more consistent spray across pulse durations, as well as smaller shifts in VMD compared to a steady state spray.

To explain the physics of pulsing sprays, first consider the sprays used for conventional, non-pulsing applications. These traditional broadcast spray applications typically take the form of flat fan sprays operating at steady state. This atomization process has been well studied in the literature. It is generally understood that the liquid exiting the nozzle orifice will form a lamella, or intact liquid sheet, which expands radially into the surrounding quiescent air. The difference between the liquid and air densities and velocities will initiate the growth of instabilities in the lamella, which propagate to eventually puncture the lamella and produce the droplets in the spray.

In the center of the lamella the liquid will have a greater velocity than the quiescent air and due to the no-slip boundary at the liquid-air interface the lamella will accelerate the ambient air, however the air will resist this acceleration due to inertia. This viscous coupling at the interface of the two fluids with unequal velocities leads to the growth of a Kelvin-Helmholtz instability. This instability characteristically produces a flapping in thin films, such as the lamella in a flat fan spray. As the lamella expands and the instability grows, the lamella will thin at the nodes of the wave until the liquid film is ruptured, leading to the formation of ligaments. The ligaments will then break into droplets up due to Rayleigh-Plateau instabilities caused by local variations in the curvature of the ligaments and the liquid surface tension. At the edges of the lamella, the liquid expands into the quiescent air. As the liquid has greater density than the air, which resists the expansion of the lamella, the edges of the spray produce a system where a less dense fluid is exerting a force on a more dense fluid, which is the classical condition required to develop a Rayleigh-Taylor instability, with a characteristic finger growth at the air-liquid interface. These fingers form at the most unstable wavelength in the system, and as they grow, they eventually pinch off to form droplets on the edges of the spray.

As there are two distinct mechanisms responsible for the formation of droplets in flat fan sprays, it is reasonable to expect that each mechanism will result in droplets of different sizes. Additionally, as these mechanisms are spatially discrete, with the Kelvin-Helmholtz instability localized to the center of the lamella, and the Rayleigh-Taylor instability localized to the edges of the lamella, any difference in the size of droplets produced should also be spatially resolved. This corresponds with previously reported observations in the literature in which a larger volume median diameter (VMD) was measured at the edges of the spray compared to the droplets produced in the center of the spray. This supports the hypothesis that as the atomization mechanism changes there should be a corresponding shift in droplet size produced.

In the case of pulsing sprays, the atomization will be constantly in a state of transience. Compared with the steady state case, each pulse will now have a leading edge at the start of the pulse, for which there is no indication that it will be governed by the same atomization mechanisms as steady state sprays. Likewise, at the end of each pulse there will now be a trailing edge, for which again there is no expectation that it will behave similarly to the spray at steady state. If the spray pulse duration is long enough it is possible that the spray will reach a steady state atomization for some fraction of each pulse. However, as the pulse duration varies the fraction of each pulse which is governed by the transience of the leading and trailing edges of the spray will shift, resulting in a shift in the time averaged droplet size distribution. This hypothesis is supported in the literature with previous studies reporting a measurable shift in spray characteristics when pulsing. These studies have primarily focused on pressure fluctuations caused by the termination of the pulse as the source of the shift in VMD and have not focused on atomization mechanisms or the role of the fluid components of the spray.

The present disclosure characterized the shift in droplet size distribution (DSD) relative to steady state for pulsing sprays as a function of the pulsing characteristics such as pulse frequency and duration, as well as the nozzle and fluid components. It also identified which factors contribute to the shift in VMD and identified the physical mechanism by which those factors produce any observed shifts in the DSD. Finally, non-dimensional scaling was be evaluated as a method to collapse the observed shifts in DSDs.

In the present disclosure it was shown that pulsing sprays with pulse durations in the range of 15 to 75 ms induces a shift on the order of up to 10% from the steady state VMD, both in the positive and negative direction. It was shown that this shift is dependent on both the pulse duration as well as the pulse frequency and is not constant across the nozzles and tank mixtures measured herein. Generally, it was found that this shift is both smaller on average and spans a smaller range across pulsing durations when an oil-in-water emulsion is included in the tank mixture, either alone or in combination with an additional surfactant. Neither the atomization time scale nor the transience duration of the sprays measured herein were found to be satisfactory time scales to normalize the DSD shifts in the pulsing sprays in the present disclosure.

While pulsing sprays shift the DSD with all types of sprayers and all solutions, it was discovered that emulsion forming adjuvants such as emulsifiable concentrates consisting of a surfactant blended into an oil may be used to reduce the change in DSD produced by the pulsing sprays. This improvement in DSD in pulsed sprays caused by the inclusion of emulsion forming adjuvants is present not only when the adjuvant is used alone in water, but it is also when the emulsion is used in combination with surfactants such as surfactant loaded herbicides. This is particularly important because the solutions including surfactant loaded herbicides experienced a greater increase in DSD. However, when the surfactant is used in combination with an emulsion forming adjuvant, the impact of the surfactant on DSD is reduced or eliminated.

Emulsion forming adjuvants which may be useful in various embodiments for reducing the change in DSD include emulsifiable concentrates which form oil-in-water emulsions such as commercially available adjuvant solutions like INTERLOCK. The adjuvant may be present at an effective level in the sprayed solution, such as greater than about 0.1% v/v or more, such as about 0.1% v/v to about 0.3% v/v, or about 0.2% v/v (4 oz/a at 15 GPA).

Emulsion forming adjuvants for use in pulsed spray distribution may include an emulsifiable concentrates consisting of an oil and surfactant blend. The oil phase may be a seed oil such as a methylated seed oil. In some embodiments, the oil phase may be a fatty acid ester such as an alkyl fatty acid ester such as one alkyl fatty acid ester.

The oil phase may be used in combination with one or more surfactants as an adjuvant to reduce the increase in DSD cause by the surfactants when sprayed in a pulsed spray system. Examples of surfactants which may be used include nonionic surfactants such as linear or nonyl-phenol alcohols and/or fatty acids, sorbitan ester, sorbitan fatty acid esters, aryl alkoxylates, alkoxylated fatty alcohols, alkoxylated fatty acids, alkoxylated triglycerides, alkoxy copolymers, alkylpolyglucosides, alkoxylated fatty amines, and ether amine. Examples of anionic surfactants, which may be used include sulfonic acids, sulfonic acid esters, alkylsulfosuccinic acid esters, phosphate esters, sulfate esters, and oleoyltaurate salts. Other examples of surfactants which may be used in various embodiments include calcium dodecylbenzene sulfonate, alkylphenol ethoxylate-based surfactants, alcohol ethoxylate-based surfactants, polyoxyethylene sorbitan fatty acid ester vegetable oil, and organosilicones. Still other surfactants which are included in herbicide, insecticide, fungicide and/or growth regulating solutions may be used. In some embodiments, the emulsion forming adjuvant may be combined with a pesticide and/or growth regulating solution including one or more surfactants which may be the same or different from those in the emulsion forming adjuvant and then distributed to crops in a pulsed spray system. In some embodiments, the emulsion forming adjuvant includes one or more oil-soluble surfactant and the pesticide and/or growth regulating solution with which is it combined includes one or more is combined includes one or more water soluble surfactants.

The surfactant component of the emulsion forming adjuvant may include one or more anionic surfactants, one or more nonionic surfactants, or a combination of both anionic and nonionic surfactants. For example, the surfactant component may include 1 part anionic surfactant and 2 parts nonionic surfactant. In some embodiments, the ratio of anionic surfactant to nonionic surfactant is about 0.6 to about 2.0. In one embodiment, the solution includes 1 part by weight of a 60% solution of at least one surfactant such as an anionic surfactant in 2-ethylhexanol and 2 parts by weight nonionic surfactant. In some embodiments, the surfactant includes at least one anionic surfactant and at least one nonionic surfactant but does not include alkoxylated sorbitan fatty acid ester.

In addition to an oil phase and one or more surfactants, the emulsion forming adjuvant may include additional components such as fatty acid. For example, when used with a fungicide, the solution may include a fatty acid in addition to the oil phase and the one or more surfactants.

Various embodiments include providing an emulsion forming adjuvant including an oil phase and optionally one or more surfactants, as well as one or more active ingredients such as herbicides, insecticides, fungicides and/or plant growth regulators to a crop as a pulsed spray application. For example, the fungicide, insecticide, herbicide and/or plant growth regulator solution may include an adjuvant of at least about 95 wt %, or about 95 wt %, of an alkyl fatty acid ester and about 3 wt %, or about 5 wt %, or about 3 wt % to about 5 wt % of a surfactant, which may include at least 1 anionic surfactant and at least 1 nonionic surfactant and optionally may include a fatty acid. In some embodiments, the ratio of the adjuvant to the active ingredients such as fungicides, insecticides, herbicides and/or plant growth regulators may be approximately 1 to 1.

Various embodiments may further include combining an emulsion forming adjuvant including the oil phase and optionally one or more surfactants with the herbicide, insecticide, fungicide and/or plant growth regulators to form a solution, and then applying the solution to a crop using a pulsed spray application. Surfactant may alternatively or additionally be present in the herbicide, insecticide, fungicide and/or plant growth regulator solution, and the method may include combining the adjuvant including the oil phase with the surfactant containing, or additional surfactant containing herbicide, insecticide, fungicide and/or plant growth regulator composition, and then applying the combined solution to a crop using a pulsed spray application.

Various parameters may be used for the pulsed spray application of the solution to achieve improved DSD. For example, the frequency may be about 4 Hz to about 30 Hz, or about 10 Hz to about 30 Hz. The duty cycle may be about 0 to about 100%, such as about 15% to about 75%. In some embodiments, the pulse duration may be about 15 ms to about 75 ms and the frequency may be 10 Hz. In some embodiments, the frequency and/or duty cycle may vary during the pulsed spray application, such as with pulse width modulation techniques and/or machine vision controlled spot spraying.

Crops which may be treated using the solutions described herein include corn, soybean, wheat, barley, oats, beans, and other crops.

The herbicides, insecticides, fungicides and/or plant growth regulators which may be used in various embodiments as active agents include commercially available products such as ROUNDUP, as well as other formulations. Plant growth regulators which may be used include one or more of auxin, gibberellin and cytokinin, which may likewise be a commercially available plant growth regulating compositions.

Regardless of the formulation with which it is used, the emulsion forming adjuvant including the oil phase and optionally one or more surfactants can help reduce the impact of pulse spray delivery on DSD, which may aid in efficient and controlled delivery of the active agent. For example, the formulation may reduce drift from the intended target and reduce splash and bounce, improving coverage as compared to formulations delivery by pulsed spray without the adjuvant.

Experimental In the present examples the sprays were all pressure driven, with the spray liquid mixed in a pressure vessel connected to the spray nozzle mounted inside a low-speed, recirculating wind tunnel via stainless steel and Teflon tubing. The enclosed wind tunnel provided containment for the spray and created a controllable and well instrumented environment to perform the measurements herein. To introduce pulsing in the spray, a TecJet quick attach nozzle body fitted with a Capstan T24 solenoid was installed in the spray line, which was in turn controlled by a Capstan Evo PWM controller. This configuration allowed for mounting commercial spray nozzles typical of those used in field applications, while also providing independent control of the pulse frequency to values between 4 and 30 Hz, and of the pulse duty cycle (DC) to control the pulse duration. With this configuration a minimum spray duration of 12 ms achievable, while still allowing for a steady state spray via 100% DC. During pulsing the quick shutoff of the solenoid produced water hammer, which made the pressure, as measured at the nozzle, fluctuate. To set the spray pressure, the DC was set to 100% to produce a steady state spray and the source pressure was adjusted until the pressure at the nozzle measured 275 kPa, then the same source pressure was used for all pulsing conditions.

The five nozzles used in the present examples were chosen from commercially available, hydraulic flat fan nozzles. The same nominal class of nozzle was used to minimize differences between the systems and reduce the complexity of inter-nozzle comparisons. These nozzles were selected based on their manufacturer specified ASABE S572.3 size classification at a fixed orifice size. By operating at a common pressure, the fixed orifice size should minimize differences in the flow rate between the various nozzles, while encompassing a wide range of droplet sizes typical of field application. The nozzles chosen, along with the manufacturer specified size classifications and the designation used in the present disclosure are listed in table 1. All nozzles selected herein are recommended by their respective manufacturer for pulsing applications.

TABLE 1
Nozzle selection for the sprays investigated
in the present disclosure.

| | | ASABE S572.3 | |
|---|---|---|---|
| Nozzle | Manufacturer | Classification | Designation |
| UR11004 | Wilger | Ultra Coarse | UC |
| SD11004 | Greenleaf | Extremely Coarse | XC |
| LDM12004 | John Deere | Very Coarse | VC |
| BP11004 | Greenleaf | Coarse | C |
| XR11004 | TeeJet | Medium | M |

Previous studies of steady state sprays have shown that the size of the lamella, and therefore the corresponding atomization time scale, is influenced by the tank mixture components. Specifically, the addition of surfactants has been shown to increase the length of the lamella prior to atomization. Likewise, the addition of an oil-in-water emulsion has been shown to decrease the length of the lamella. In order to investigate the role of this atomization timescale on the pulsing sprays multiple tank mixtures were considered. Water alone was chosen as the baseline reference (treatment W) which the other treatments could be compared against, with three additional tank mixtures selected to intentionally vary the atomization time scale and observe its influence on the DSD produced when pulsing. To add surfactant to the tank mixture, a heavily surfactant loaded herbicide was used (treatment H), to add an oil-in-water emulsion to the tank mixture an emulsion forming drift control adjuvant was used (treatment E), and lastly a combination of the herbicide and drift control adjuvant was used (treatment HE) in order to observe interactions between the two competing influences on the breakup timescale. These tank mixtures were prepared with commercial agricultural products at use rates according to the label requirements. This ensures that the results herein will be representative of agriculturally relevant sprays. Details of the tank mixtures used herein are presented in table 2. Each tank mixture was measured with each nozzle in the present examples. The mixture fractions are reported as volume percentage, and for the H, E, and HE mixtures the balance is water.

TABLE 2
Tank mixtures and associated designations
for the sprays investigated herein.

| Tank Mixture | Designation |
|---|---|
| 100% Water | W |
| 1.6% ROUNDUP POWERMAX 3 | H |
| 0.2% INTERLOCK | E |
| 1.6% ROUNDUP POWERMAX 3 + | HE |
| 0.2% INTERLOCK | |

The pulse duration was controlled by selecting combinations of pulse frequency and duty cycle which produced the desired pulse length. Additionally, a baseline spray was measured with the spray operating at steady state in order to determine the magnitude of shifts in DSD attributable to pulsing the spray as opposed to those resulting from changing the nozzle and tank mixture. For the water treatments, the pulse durations were measured at multiple pulse frequencies to determine if there was an influence on the resulting DSD attributable to the frequency, or if the pulse duration was the dominant factor. For the rest of the treatments a fixed frequency was used. The details of the pulsing parameters are reported in table 3.

TABLE 3
Pulse parameters for the pulse durations investigated herein.

| Pulse | Pulse | Duty | |
|---|---|---|---|
| Duration, ms | Frequency, Hz | Cycle, % | Tank Mixtures |
| Steady State | 10 | 100 | W, H, E, HE |
| 75 | 10 | 75 | W, H, E, HE |
| 50 | 10 | 50 | W, H, E, HE |
| 50 | 15 | 75 | W |
| 25 | 10 | 25 | W, H, E, HE |
| 25 | 20 | 50 | W |
| 25 | 30 | 75 | W |
| 15 | 10 | 15 | W, H, E, HE |
| 15 | 20 | 30 | W |
| 5 | 301 | 45 | W |

To visualize changes in the atomization mechanism induced by pulsing a qualitative observation of the sprays was made with high speed shadowgraphy. For these observations the nozzle was oriented downward, and no wind was used. The spray was backlit with a HardSoft IL-105G LED illuminator diffused through Dura-Lar drafting acetate and imaged with a Phantom V2012 high speed camera. Two different imaging configurations were used, a wide view capturing the entire lamella breakup was captured with a 10 μs exposure at a 22 kHz sample rate using a 100 mm Nikor lens; a narrow view of the lamella immediately proximate to the nozzle orifice was captured with the same sample rate and exposure using a long-distance working microscope objective.

In addition to the qualitative visualizations described above, qualitative measurements of the sprays were performed by measuring shifts in the DSD of these sprays via laser diffraction (LD) interferometry (Sympatec Helos KR) with the wind tunnel operating at 6.7 m/s and the spray oriented parallel to the wind to minimize velocity induced size resolved measurement bias. The spray was traversed throughout the measurement, beginning with the entire spray fan positioned above the LD measurement volume, then slowly traversed for 15 s at a constant speed of 0.08 m/s through the measurement volume and ending with the entire spray fan positioned below the measurement volume. This ensures that the DSD measurements in the present examples are a representative ensemble average accounting for spatial variations across the span of the spray. The LD instrument samples the DSD every 3 μs during the 15 s measurement, then convolutes the temporally disparate measurements to produce a temporally averaged measurement. As the LD sample rate is orders of magnitude higher than even the fastest pulse frequency considered in the present examples, the temporal averaged DSD measured herein is well resolved for even the fastest pulsing configurations investigated in the present examples. Likewise, the traverse speed of the spray is slow enough that even for the slowest pulse frequency, multiple periods of the pulsing spray are measured at each location along the span of the spray, ensuring that the DSD measurement is also able to fully resolve the slowest pulsing configurations investigated herein.

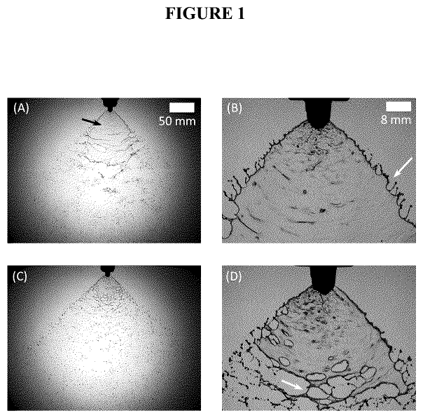

VISUALIZATION OF PULSE TRANSIENCE. Representative stills of the sprays operating at steady state are presented in FIG. 1 in both wide and close up views. The still images are of steady state sprays taken from the XC nozzle, in which selections from the H treatment are shown in images (A) and (B), with (A) showing a wide shot encompassing the complete atomization, and image (B) presenting a close up showing more clearly the intact lamella, and selections from the E treatment are shown in still images (C) and (D), with image (C) presenting the same wide shot as in image (A), and image (D) the same close up as in image (B). During steady state spraying typical of conventional broadcast applications, the flat fan spray will consist of an intact lamella at the nozzle orifice, which experiences a Kelvin-Helmholtz instability in the center of the lamella, which can be observed in image (A) as indicated by the with the arrow, and a Rayleigh-Taylor instability at the edges of the lamella, which can be observed in image (B) as indicated with the arrow. Therefore, the high speed shadowgraphy is able to well resolve this phenomenon. Likewise, as discussed in the introduction, the addition of an emulsion to the spray is known to cause earlier breakup via the nucleation of perforations within the lamella. These perforations are observed in images (C) and (D) as indicated with the arrow in image (D). This phenomenon is also well captured by the shadowgraphy produced herein. Therefore, as this imaging technique is able to resolve the expected steady state phenomena, we have confidence that it will also capture the transience at the leading and trailing edges of the pulsing sprays.

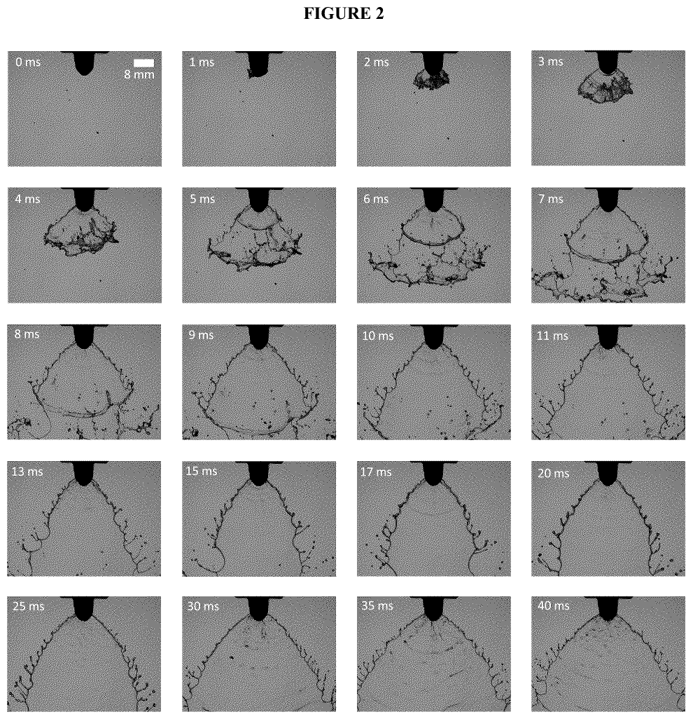

The leading edge of a spray pulse is presented in the time series in FIG. 2. FIG. 2 presents a time series of still images showing a close up view of the leading edge of a spray pulse taken from the XC nozzle using the surfactant laden herbicide treatment. The elapsed time from the initial observation of liquid accumulating at the nozzle orifice is labeled for each frame. The first 10 ms are shown in 1 ms time steps and the subsequent 30 ms are shown in increasing time steps.

As FIG. 2 shows, immediately preceding the pulse the nozzle orifice is free of liquid and the majority of droplets produced in the previous pulse have exited the field of view. At 1 ms liquid has begun to accumulate in the nozzle orifice, but still is attached to the nozzle due to surface tension. At 2 ms enough pressure has built up to eject the accumulated liquid from the orifice, producing an advancing liquid front. By 3 ms into the pulse there is now clear separation between the relatively thick leading rim of the lamella, and a thinner lamella forming behind it which is visibly more transparent, indicating that it is less energetic than the leading rim. At 4 ms the leading edge of the pulse is starting to shed the thicker rim observed at 3 ms by forming ligaments perpendicular to the lamella. This thicker region appears to be traveling slower than the rest of the progressing front. There also appears to be the beginning of fingering instabilities visible on the left of the lamella front opposite the thicker rim. The rest of the lamella appears to show small transverse waves; however, they are significantly damped compared to those observed at 3 ms. At 5 ms two distinct regions within the lamella have developed, a relatively quiescent region near the leading edge (the outer region), and a disturbed region near the nozzle (the inner region). In the outer region there are clear finger structures forming at the edges of the lamella. At 6 and 7 ms this region begins to separate from the attached lamella, and small perforations begin to appear in the outer portion of the lamella. The inner portion of the lamella starts to exhibit finger structures at the edges at this time. By 10 ms the outer region has exited the field of view and completely separated from the inner region, which now comprises the entirety of the lamella, however the included angle of the lamella is still much smaller than the steady state spray as depicted in image (B) of FIG. 1. The interior of the lamella exhibits some wavelike structures near the nozzle orifice; however, they are not yet clearly structured into the radial transverse waves expected of a Kelvin-Helmholtz instability as shown in image (B) of FIG. 1. At 15 ms clear radially propagating transverse waves are visible in the lamella, however the included angle remains much smaller than expected for steady state. The included angle grows slowly until at 40 ms it is nearly the size of the steady state lamella. In addition to increasing the included angle, the thickness of the finger structures at the edges of the lamella correspondingly decreases in thickness. This is expected from a conservation of mass perspective, as the increasing lamella angle for a fixed fluid volume would correspond with a thinning of the lamella, resulting in smaller structures, that in turn would produce smaller droplets as they pinch off. This time series confirms the hypothesis that the leading edge of the spray experiences distinct atomization mechanisms compared with the spray at steady state. Additionally, it shows that there are multiple distinct phases the spray transitions through during the leading edge transience, each likely producing distinct size droplets, and there is significant time required for the spray to visually reach steady state.

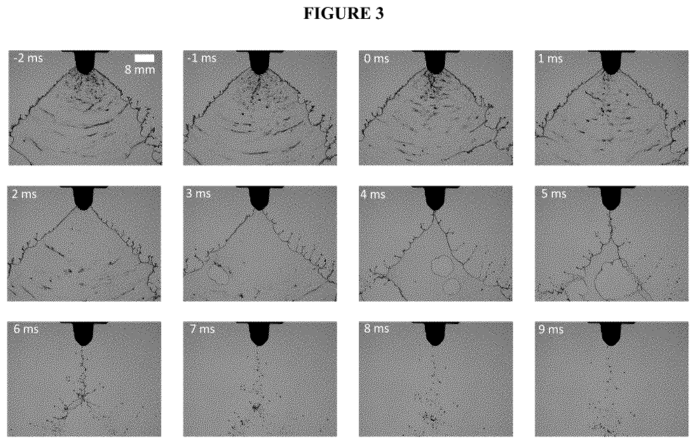

The trailing edge of the pulse is presented as a time series in FIG. 3. The time series of still images in FIG. 3 shows a close up view of the trailing edge of a spray pulse taken from the XC nozzle using the surfactant laden herbicide treatment. The elapsed time from the initial observation of a change in the lamella is labeled on each frame, with a 1 ms time step. As this figure shows, immediately prior to the pulse ending the spray is operating at steady state, very similar to the spray presented in image (B) of FIG. 1. At 1 ms the angle of the lamella can be observed to begin retracting near the nozzle, while the lamella further out is still carried by its inertia at the same angle as the steady state condition. Additionally, the intensity of the transverse waves in the lamella is noticeably reduced compared to the steady state condition. At 2 ms the lamella continues to retract, and near the orifice there are no longer any radially expanding transverse waves, with the only visible waves present being azimuthal waves radiating from the orifice. The wave intensity in the rest of the lamella has decreased and the size of the finger structures at the edges of the lamella have grown significantly in length. At 3 ms the lamella has retracted further, and nearly the entire lamella is now quiescent, without well defined disturbances in the lamella. Additionally, the finger structures have continued to grow and begin to shed chains of droplets. At 4 ms the lamella is only attached to the nozzle at a single point, and the finger structures at the receding edges of the lamella have reduced in dimeter noticeably, although they continue to grow in length. At 5 the receding edges of the lamella have intersected, and where they collide, they form alternating finger structures. By 6 ms from the solenoid shutoff the lamella has almost entirely disintegrated, and at 7 ms only droplets remain. This time series again confirms the hypothesis that the trailing edge is governed by distinct atomization mechanics compared with the steady state spray.

The extremely coarse nozzle operating with the herbicide treatment was chosen to present in FIGS. 1, 2, and 3 because this combination produces the largest lamella with the most distinct fluid structures of the combinations observed herein. This selection allows for the most clear description of the transience in each pulse when reproduced as a series of still images. Each nozzle and tank mixture measured in the present examples also present these features, however the size of the lamella and the duration of the transience varies depending on the nozzle and treatment. Table 4 tabulates the transience of each combination for both the leading and trailing edges of the pulse. For the leading edge, an estimate of the duration required for the spray to qualitatively match the spray angle as well as the general structures observed at steady state is reported as the transience time scale. Due to the imprecision of this qualitative observation, the time scale is only reported to the nearest ms. For the trailing edge, an estimate of the transience time scale was likewise made based on the duration from the first observed reduction in the spray angle and intensity of fluid structures within the lamella to the time where there was no observed intact lamella in frame.

Again, due to the imprecision of this observation, this time scale is only reported to the nearest ms. As this table shows, the largest nozzles tend to require longer durations after pulse initiation in order to reach steady state, and the addition of any of the tested tank mixture constituents tended to increase the leading edge transience compared to water alone. The trailing edge transience was observed to be relatively insensitive to both the nozzle and treatment.

TABLE 4
Transience time scales observed in the shadowgraphs.

| | Leading Edge Transience, ms | | | | Trailing Edge Transience, ms | | | |
|---|---|---|---|---|---|---|---|---|
| Nozzle | W | H | E | HE | W | H | E | HE |
| UC | 20 | 33 | 30 | 31 | 8 | 9 | 7 | 6 |
| XC | 36 | 40 | 39 | 36 | 7 | 7 | 5 | 6 |
| VC | 8 | 30 | 31 | 27 | 5 | 7 | 7 | 5 |
| C | 6 | 33 | 27 | 33 | 3 | 5 | 5 | 4 |
| M | 5 | 29 | 23 | 27 | 5 | 6 | 5 | 7 |

MEASURED DSD RESPONSE TO PULSING. The quantitative LD measurements produced full DSDs of each tested combination, however instead of presenting the full distributions for each measurement in the present examples the data is presented in a reduced form for conciseness. The volume median diameter (VMD) is the distribution statistic chosen to represent each spray. This is a widely used statistic for characterizing size distribution functions and is defined as the diameter for which half of the volume of the spray is contained in droplets of larger diameter, and the other half is contained in droplets with smaller diameter; or more formally it is the diameter corresponding to 50% on a cumulative volumetric size distribution. One objective of these examples is to determine how pulsing influences the DSDs of sprays relative to their steady state operation, a relative change was chosen to be the parameter of merit used to characterize each pulsing spray herein. The closer to zero this metric is the more similar the spray performs compared with a steady state spray of the same nozzle and treatment combination. Likewise, a positive value indicates that the pulsing spray produces larger droplets on average compared with the steady state spray and concomitantly a negative value indicates that the pulsing spray produces smaller droplets on average compared with the steady state spray.

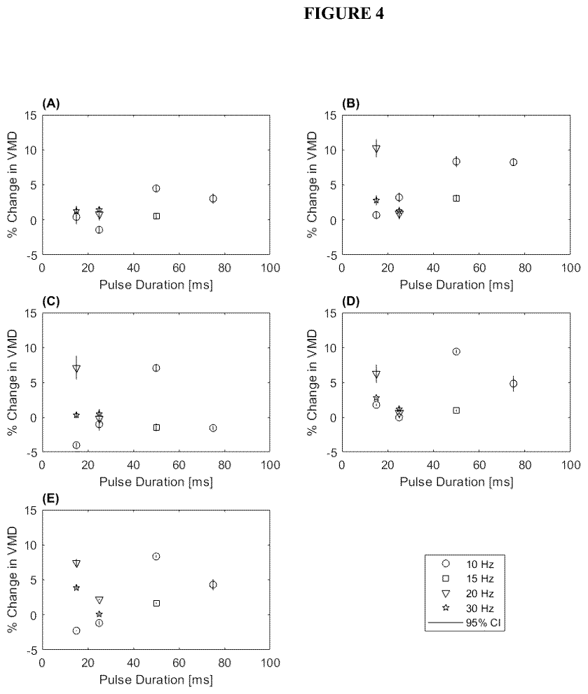

The first series of DSD measurements performed were to determine if there was an influence of the pulse frequency on the DSD, or if the pulse duration was the only significant parameter for characterizing the spray. These measurements were performed with all the nozzles, but only with the water treatment. A steady state spray and pulsing spray with durations of 15, 25, 50, and 75 ms were measured using the frequency and duty cycle combinations described in table 3. These measurements are presented in the plots in FIG. 4, with the UC, XC, VC, C, and M nozzle (graphs A, B, C, D, and E, respectively), which shows that at each pulse duration there is a measurable shift observed as the pulse frequency changes for each nozzle tested. The graphs show the % change in VMD relative to steady state for each nozzle with water shown as a function of the pulse duration for the pulse frequencies tested in the present examples with each of the nozzles. The error bars show the propagation of uncertainty of 95% confidence intervals for each measurement. The shift shown in FIG. 4 is not monotonic with changing pulse frequency, nor is it consistent from nozzle to nozzle at a given pulse duration. This indicates that there is not a universal shift which is applicable to all nozzles, and that the pulse frequency does play a role in the change in DSD observed while pulsing. This is not entirely unexpected, as there have been some measurements reported in the literature observing the pressure in the spray manifold upstream of the solenoid which observed a rapid pressure increase immediately after the valve shutoff. In commercial sprayers this is mitigated somewhat by pulsing alternate nozzles, however in the system used in the present examples there was no pressure diversion path, so the shifting VMDs observed as pulse frequency was changed could correspond with a shifting manifold pressure for each pulse duration. In order to minimize the confounding influence of this phenomena a fixed pulse frequency of 10 Hz was used for the remainder of the measurements in the present disclosure.

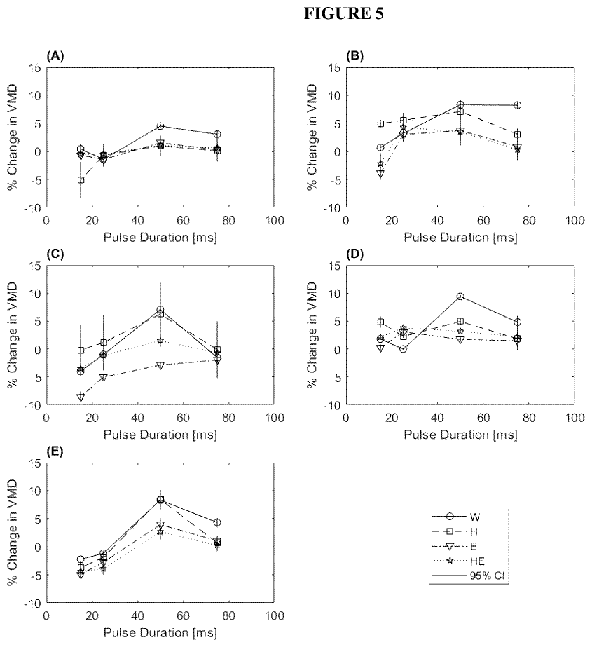

To measure the influence of the tank mixture components, DSD measurements were performed with the treatments described in table 2. Specifically, these treatments consisted of a water alone treatment, a heavily surfactant loaded herbicide treatment, an oil-in-water emulsion containing treatment, and a combination surfactant loaded herbicide and emulsion containing treatment hereafter referred to as the W, H, E, and HE treatments respectively. The results of these DSD measurements are presented in FIG. 5 for the UC, XC, VC, C, and M nozzle results (graphs (A), (B), (C), (D), and (E), respectively). The set of graphs presented in FIG. 5 show the % change in VMD relative to steady state for each nozzle used in the present examples as a function of pulse duration when operated at 10 Hz, for the tank mixtures described in table 2 with the (A) UC, (B) XC, (C) VC, (D) C, and (E) M nozzles. The error bars show the propagation of uncertainty of the 95% confidence intervals for each measurement. As the plots in FIG. 5 show, there is not a consistent shift for each treatment and nozzle combination, with each nozzle having unique shifts compared to the steady state VMD for each treatment measured. Additionally, these plots show that there is not a monotonic relationship between the pulse duration and the measured shift in the spray DSD, instead most treatments show an increase in the relative VMD as pulse duration increases reaching a maximum at 50 ms, then a reduction in the shift in relative VMD at 75 ms. Likewise, the direction of the shift in VMD is heavily dependent on the nozzle and treatment combination, with the UC, XC, VC, and M nozzles tending to produce smaller droplets at short pulse durations, while the C nozzle tends to produce larger droplets at short pulse durations. At larger pulse durations the XC, VC, C, and M nozzles tend to produce larger droplets than at steady state, while the UC nozzle tends to produce comparable sized droplets relative to steady state. There also appears to be some trends in how the nozzles are influenced by the treatments in these examples, with the W treatment tending to produce larger droplets when pulsing compared to the other treatments, and the emulsion containing treatments (E and HE) tending to produce smaller droplets across the pulsing domains and nozzles tested herein.

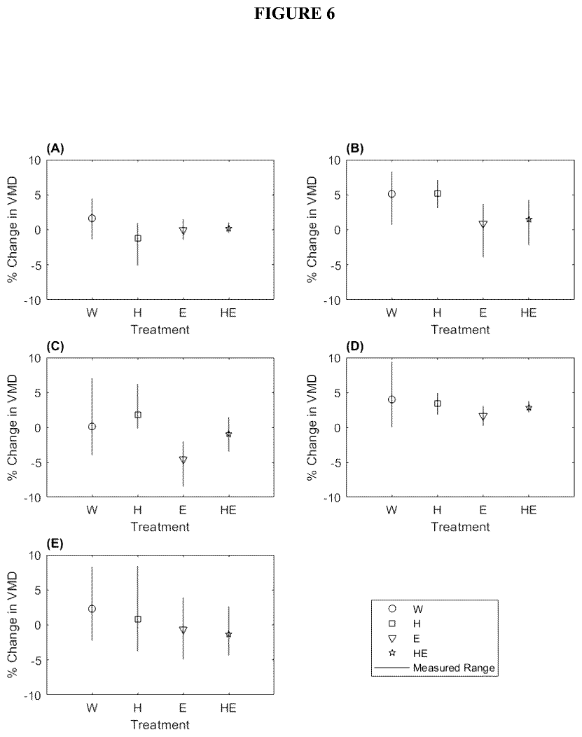

A summary of the range of changes in VMD and the average change in VMD relative to steady state for each treatment combination is presented in table 5, below. The values are based on the percent change when pulsing compared to steady state conventional broadcast spray for the same nozzle and tank mix. A negative change corresponds to smaller droplets while a positive change corresponds to larger droplets. The range is the minimum to maximum observed deviation from steady state behavior across the duty cycle measures. This is also shown as the error bars in FIG. 6, as described further below. As such, a smaller range corresponds to a more consistent spray, with more predicable drive and deposition characteristics. The average is the average of the change in VMD for each formulation of the four pulse durations/duty cycles evaluated.

TABLE 5
Percent change in VMD compared to steady state spray when pulsing at 10
Hz for 15, 25, 50, and 75 ms pulse durations when operating at 40 psi.

| | | | | | | | | ROUNDUP | |
|---|---|---|---|---|---|---|---|---|---|
| | | | | ROUNDUP | | | | POWERMAX 3 + | |
| | Spray | Water | | POWERMAX 3 | | INTERLOCK | | INTERLOCK | |
| Nozzle | Class* | Ave. | Range | Ave. | Range | Ave. | Range | Ave. | Range |
| UR11004 | UC | 1.62 | 5.91 | −1.18 | 6.10 | −0.08 | 2.97 | 0.17 | 1.55 |
| SD11004 | XC | 5.10 | 7.64 | 5.15 | 4.06 | 0.91 | 7.64 | 1.45 | 6.49 |
| LDM12004 | VC | 0.12 | 11.07 | 1.76 | 6.42 | −4.61 | 6.53 | −0.96 | 4.99 |
| BP11004 | C | 3.98 | 9.43 | 3.45 | 3.12 | 1.61 | 2.89 | 2.82 | 1.66 |
| XR11004 | M | 2.30 | 10.59 | 0.86 | 12.19 | −0.68 | 8.91 | −1.34 | 7.06 |

*Spray class according to manufacturer reported ASABE S572.3 spray classification when spraying water at 40 psi.

To better visualize these treatment responses across the pulsing domain the change in VMD relative to steady state for each nozzle and treatment combination was averaged and the result is presented in FIG. 6. The set of graphs in FIG. 6 show the % change in VMD relative to steady state for each treatment averaged across the pulsing durations tested in the present examples. Graph (A) is the UC nozzle, graph (B) is the XC nozzle, graph (C) is the VC nozzle, graph (D) is the C nozzle, and graph (E) is the M nozzle data. To visualize the extent of the shift in VMD observed, an error bar encompassing full range of measured VMD shifts across all pulsing durations is also presented in FIG. 6. The minimum and maximum values are shown as the ends of the error bars and correspond to the largest and smallest measured change in VMD, relative to steady state, for each condition. This visualization highlights some interesting trends in the measurements. First, the emulsion containing sprays tend to have the least spread in the change in VMD across the pulsing domain, with the HE treatment having the smallest spread among the measured treatments for the UC, VC, C, and M nozzles, and the E treatment having the second smallest spread among the measured treatments for the UC, VC, C, and M nozzles as well. This indicates that there will be a more consistent spray as the pulse duration shifts when using these nozzles if an emulsion is present in the spray, either by itself or combined with a surfactant. Additionally, this observation implies that the shift in atomization mechanism resulting from the addition of an emulsion to the tank mixture is dominant over the effect resulting from the surfactant as the HE treatment performs more similarly to the E treatment than the H treatment. The second interesting trend is that the W treatments tended to have the largest average shift from the steady state VMD, with the UC, VC, C, and M nozzles specifically having the largest average deviation with the W treatment, and the XC nozzle has the W treatment at approximately the same deviation as the H treatment. This is contrasted with the emulsion containing sprays, which tend to have less deviation from the steady state spray on average, with the E treatment having less than 1% deviation from the steady state VMD on average for the UC, XC, C, and M nozzles, while the HE treatment has an average of less than 1% deviation from steady state on the UC and VC nozzles. The only other treatments measured having such a small average deviation from steady state are the W treatment with the VC nozzle, and the and the H treatment on the M nozzle. This indicates that the spray will behave more similarly compared to what would be expected of a more conventional spray for these nozzles operating at these pulsing regimes when the treatment contains an emulsion. Again, this observation reinforces the implication that the influence of the emulsion is dominant over that of the surfactant, as the HE treatment again behaves more similarly to the E treatment than the H treatment across the tested nozzles.

From table 5 and FIG. 6, it can be seen that the surfactant loaded herbicide (H treatment) increased the range of change of the DSD and therefore when used in a pulsed spray delivery. However, when the emulsion was added (HE treatment), there was a substantially less increase in the range of change of droplet sizes in the pulsed spray delivery. The inclusion of the emulsion generally resulted in about 25% to about 75% smaller change in DSD while pulsing as compared to the change observed with the herbicide alone while pulsing, across most nozzle types.

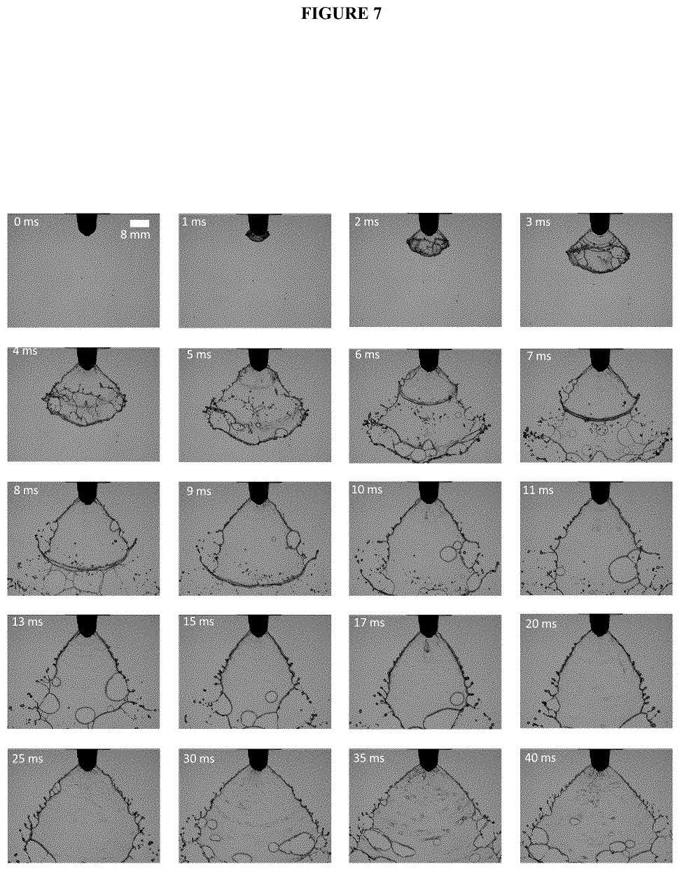

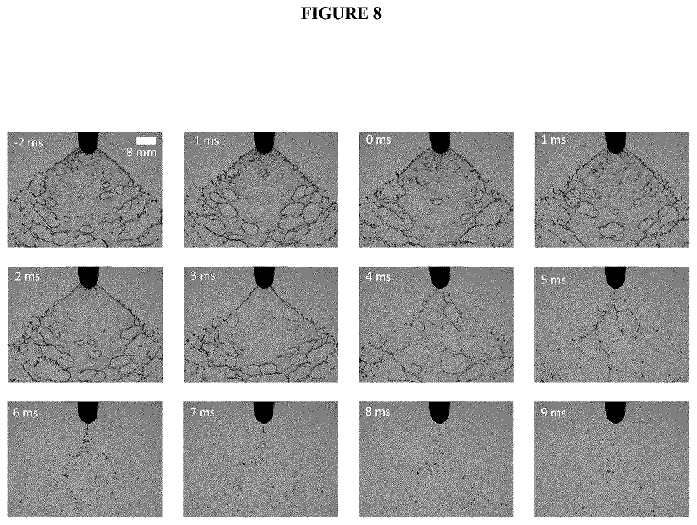

A possible explanation for why the emulsion containing sprays tend to produce more uniform DSDs across the pulsing domain, as well as DSDs that exhibit less deviation from steady state is related to the shift in atomization mechanism associated with the emulsion containing sprays. As FIG. 1 showed, the emulsion containing sprays experience perforations within the lamella, which tends to cause the lamella to break up primarily through ligament mediated atomization show in images (C) and (D), as opposed to the thin film rupture associated with the Kelvin-Helmholtz instability show in image (B) of FIG. 1. To identify how these perforations interact with the pulsing spray, a time series of both the leading and trailing edges of a pulse are presented in FIGS. 7 and 8 respectively for the E treatment on the XC nozzle. FIG. 7 is a time series of still images showing a close up view of the leading edge of a spray pulse taken from the XC nozzle using the emulsion treatment. The elapsed time from the initial observation of liquid accumulating at the nozzle orifice is labeled for each frame. The first 10 ms are shown in 1 ms time steps and the subsequent 30 ms are shown in increasing time steps. FIG. 8 is a time series of still images showing a close up view of the trailing edge of a spray pulse taken from the XC nozzle using the emulsion treatment. The elapsed time from the initial observation of a change in the lamella is labeled on each frame, with a 1 ms time step.

As FIG. 7 shows, the perforations are evident in the lamella as early as 5 ms after the pulse, when the thick leading edge is still in frame, and the secondary inner region of the lamella has yet to form. As the inner region forms, the outer region begins to disintegrate via the lamella perforation mechanism characteristic of emulsion containing sprays, until it is only a network of ligaments at 8 ms. Likewise, the lamella perforations begin within the bulk of the lamella as early as 10 ms after pulse initiation, far earlier than the duration required for the lamella to exhibit the included angle and fluid structures of the steady state spray shown in image (D) of FIG. 1. Conversely, for the trailing edge of the pulse as the lamella begins to rapidly collapse, a network of perforations is nucleated within the lamella, visible at 3 and 4 ms in FIG. 8. By 5 ms after the termination of the pulse the lamella has collapsed into a ligament network, with little of the energetic fingering observed in FIG. 3, and very reminiscent of the ligament network formed during steady state spraying with an emulsion. This would indicate that for a greater fraction of the pulse the emulsion mediated atomization is dominant, resulting in a spray that is less sensitive to the transience associated with the initiation and termination of the pulse.

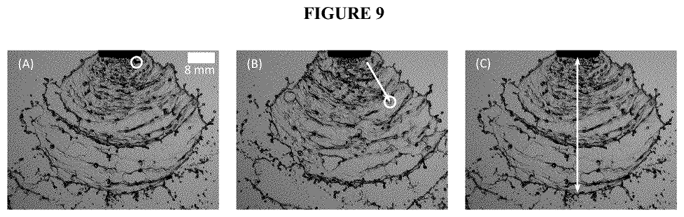

EVALUATING TIMESCALES FOR NORMALIZATION. FIG. 9 is a set of still images demonstrating the method used for determining physical parameters related to the lamella demonstrated with the UC nozzle with the water treatment. To determine the velocity of the lamella a fluid structure is identified in image (A) and is tracked to a subsequent frame image (B), the velocity is then calculated from the pixel displacement and number of intervening frames. The Lamella intact length is measured from the center pixel of the nozzle to the end of the intact region of the lamella as shown in image (C). To better characterize the influence of the nozzle-treatment combinations on the physical characteristics of the lamella the high-speed shadowgraphs were quantitatively measured to identify both the average intact length of the lamella (image (A) of FIG. 9), as well as the outlet velocity of the liquid from the nozzle orifice (image (B) of FIG. 9). These measurements were performed only on the steady state sprays to minimize any confounding factors introduced by the pulsing transience. To measure the lamella intact length, the center of the nozzle was identified in each shadowgraph, then a measurement was made vertically down to the point where the lamella was no longer intact along the centerline of the nozzle, as shown in image (C) of FIG. 9. These measurements were performed on 30 frames of each shadowgraph, with 100 frame intervals between measurements to ensure independent measurements were achieved.

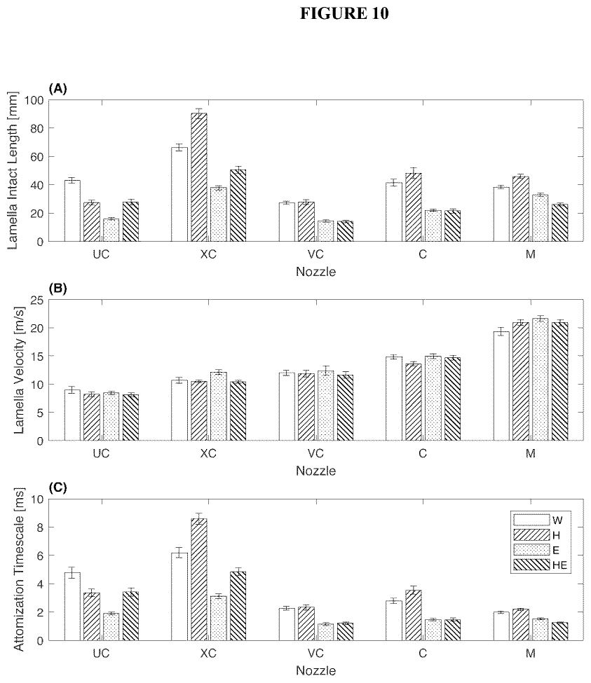

The result of these measurements are presented in FIG. 10. FIG. 10 presents a set of graphs of the physical characteristics of the lamella in each spray as measured in steady state with graph (A) showing the averaged intact length of the lamella and the error bars showing a 95% confidence interval, graph (B) showing the velocity of the lamella near the orifice and the error bars showing a 95% confidence interval, and graph (C) showing the atomization time scale for each spray and the error bars show a propagation of uncertainty from the 95% confidence intervals in graphs (A) and (B). To measure the outlet velocity of the liquid from the nozzle orifice, a fluid structure was identified in the lamella near the orifice, such as the one shown circled in image (A), then tracked through a series of frames until it became no longer distinct, as shown in image (B) of FIG. 9. The absolute displacement of the fluid structure, along with the intervening number of frames was used to calculate the velocity of the lamella. This measurement was performed with 10 replicates for each nozzle-treatment combination, with 100 frames between the end of one measurement and the start of a subsequent measurement to ensure independence. The resulting velocities and associated 95% confidence intervals are presented in graph (B) of FIG. 10. Finally, these length scales and velocities were used to calculate an atomization timescale, presented in graph (C) of FIG. 10, for each combination by dividing the length of each lamella by its velocity to get the duration required for a fluid packet to transit from the nozzle orifice to the end of the lamella where it forms a droplet.

These measurements confirm the previous literature observations as measurements of the surfactant laden herbicide containing spray herein tend to have the longest intact lamella length and the measurements of the oil-in-water emulsion containing sprays herein tend to have the shortest lamella length for the majority of nozzles tested. The exit velocity of the lamella tends to be relatively insensitive to the treatment, and instead is primarily determined by the nozzle selection, with the nozzles producing smaller droplets tending to produce faster lamellas. This is consistent with conservation of energy in the pipe, as the nozzles which produce smaller droplets, also tend to have a smaller orifice, and there is no viscosity modifying component in any of the treatments measured herein. The atomization timescale, therefore, tends to be primarily dominated by the lamella intact length, with only slight variations attributable to the lamella velocity.

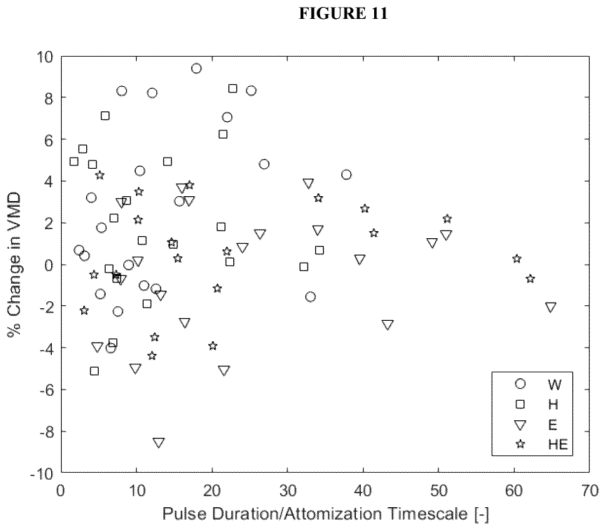

To determine if the shift in atomization time scales attributable to the nozzle and treatment combinations can account for the shifts observed in VMD the data from FIG. 5 has been scaled by the atomization timescale for each combination. This produces a relative timescale which is equal to the number of times a fluid packet could exit the nozzle and break up into droplets within the pulse duration. This dimensionless pulsing data is presented in FIG. 11, which is a graph of the % change in VMD relative to steady state as a function of the pulse duration scaled by the atomization timescale. As this figure shows, there is little correlation between the measured shifts in VMD and the relative timescale used, indicating that this metric alone does a poor job of capturing the relevant physics contributing to the observed shift in VMD with the pulsing sprays.

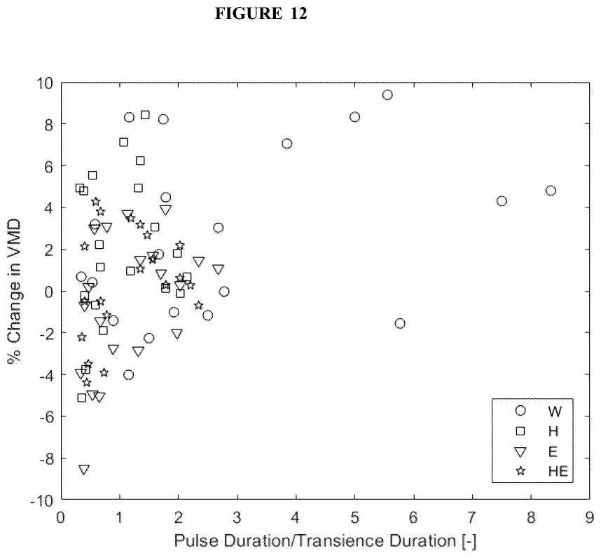

Instead of using the atomization timescale, an alternate timescale to normalize the data from FIG. 5 with is the duration of the pulse in the transient regime at the leading and trailing edges of the spray. To calculate this, the pulse duration for each combination was scaled by the sum of the leading and trailing transience duration estimates from table 4, with values less than unity indicating that the lamella never reaches steady state, and values greater than unity indicating the proportion of each pulse which operates at steady state. The resulting relationship is presented in FIG. 12, which is a graph of the % change in VMD relative to steady state as a function of the pulse duration scaled by the duration of each pulse within the transient leading and trailing edges. As this figure shows, this method for normalizing the data is still poorly correlated, again indicating that there are other physics to consider when parameterizing these pulsing sprays.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. An agricultural treatment configured to be applied in a field by spraying that is pulsed, comprising:
a. a crop treatment having at least one active ingredient; and
b. a sufficient quantity of an adjuvant comprising an oil phase to provide a more consistent droplet size during pulsed spray application of the agricultural treatment.

2. The agricultural treatment of claim 1, the adjuvant further comprising a sufficient quantity of surfactant to provide the more consistent droplet size during pulsed spray application of the agricultural treatment.

3. The agricultural treatment of claim 1, wherein the sufficient quantity of oil phase is configured to provide smaller shifts in volumetric median diameter and droplet size distribution when applied by spraying that is pulsed compared to a steady state spray.

4. The agricultural treatment of claim 3, wherein the oil phase comprises a fatty acid ester.

5. An agricultural treatment configured to be applied in a field by spraying that is pulsed, comprising:
a. a crop treatment having at least one active ingredient; and
b. a sufficient quantity of an emulsion forming adjuvant to provide a more consistent droplet size distribution during pulsed spray application of the agricultural treatment.

6. The agricultural treatment of claim 5, wherein the emulsion forming adjuvant comprises a drift control adjuvant.

7. The agricultural treatment of claim 5, wherein the crop treatment comprises an herbicide, insecticide, fungicide and/or plant growth regulators and one or more surfactants.

8. The agricultural treatment of claim 5 wherein the emulsion forming adjuvant comprises a sufficient quantity of oil phase to provide a spray distribution when delivered by a pulsing regime that is closer to what would be expected of a conventional spray.

9. The agricultural treatment of claim 8 wherein the oil phase comprises a fatty acid ester.

10. The agricultural treatment of claim 9 wherein the emulsion forming adjuvant comprises a sufficient quantity of oil phase to provide a droplet size distribution, when applied by a pulsing regime, that is closer to what is expected of a conventional spray.

11. The agricultural treatment of claim 10, further comprising a surfactant comprising a nonionic surfactant and an anionic surfactant.

12. A method of reducing the impact of pulsed spray delivery of a crop treatment on droplet size distribution, the method comprising:
applying a crop treatment to a crop in a pulsed spray, the crop treatment comprising:
one or more active ingredients comprising an herbicide, insecticide, fungicide and/or plant growth regulator; and
an adjuvant comprising an oil phase and one or more surfactants.

13. The method of claim 12 wherein the pulsed spray comprises a spray at about 10 Hz to about 30 Hz.

14. The method of claim 12 wherein the pulsed spray comprises a spray at a duty cycle of about 15% to about 75%.

15. The method of claim 12 wherein the oil phase comprises a fatty acid ester.

16. The method of claim 15 wherein the oil phase comprises a one alkyl fatty acid ester.

17. The method of claim 16 wherein the oil phase comprises methylated seed oil.

18. The method of claim 12 wherein the one or more surfactants comprises a nonionic surfactant and an anionic surfactant.

19. The method of claim 18 wherein the oil phase comprises at least about 95 wt % of the adjuvant and the surfactant comprises about 3 wt % to about 5 wt % of the adjuvant.

20. The method of claim 19 wherein the oil phase comprises a fatty acid ester and at least one surfactant comprises a nonionic surfactant and an anionic surfactant.
